(19) United States
(12) Patent Application Publication
(10) Pub. No.: US 2015/0331594 A1
(43) Pub. Date: Nov. 19, 2015

(54) CONTENT DISPLAY DEVICE, CONTENT DISPLAY METHOD AND PROGRAM

(71) Applicant: Sharp Kabushiki Kaisha, Osaka (JP)

(72) Inventors: Satoshi TERADA, Osaka-shi (JP); Noriyuki KOYAMA, Osaka-shi (JP); Shizuka INOUE, Osaka-shi (JP)

(21) Appl. No.: 14/691,669

(22) Filed: Apr. 21, 2015

(30) Foreign Application Priority Data
May 19, 2014 (JP) 2014-102994

(51) Int. Cl. G06F 3/0484; G06F 3/0488

(52) U.S. Cl. CPC G06F 3/04845; G06F 3/0488; G06F 3/04842

(57) ABSTRACT

A content display device detects a first operation on a displayed content and determine a display magnification ratio based on the operation quantity of the first operation, displays a display image of the content that has been subjected to a first image processing for enlargement or reducing by the display magnification ratio, and, displays a display image of the content that has been subjected to a second image processing when the display magnification ratio falls beyond a first threshold range.

This Nonprovisional application claims priority under 35 U.S.C. §119 (a) on Patent Application No. 2014-102994 filed in Japan on 19 May 2014, the entire contents of which are hereby incorporated by reference.

### BACKGROUND OF THE INVENTION

(1) Field of the Invention

The present invention relates to a content display device and the like that display a content on a display screen.

(2) Description of the Prior Art

Recently, in the field of various devices for displaying the content such as computers, audio visual (AV) devices, there has been a trend toward larger screen sizes. In the medium and small-sized screens up to now, users could have displayed and operated, at most, several windows only. However, availability of large-screen display has enhanced use of displaying many pieces of content at the same time.

In order to handle many the pieces of content, there has been a known technique called gesture operation that allows the user to downsize or enlarge the view of the content by putting two fingers on the content and changing the distance between the fingers (pinch-in operation or pinch-out operation) to thereby display the content in an appropriate size the user wants to see on the large screen (see Patent Document 1, for example).

Usually, the display magnification ratio is changed in accordance with the detected operation quantity of pinch-in operation or pinch-out operation. Since the size of the user's hand is limited, if the same gesture is repeated after the end of pinch-in operation (the time of release of touch) within a predetermined period of time, the consecutive gestures may be regarded to be a single gesture.

As in Windows (registered trademark) of Microsoft Corporation and the like, in order to temporarily retract a content displayed on the screen without eliminating the content from the screen, there have been known products that are equipped with the minimize button. A product of this kind has a function that, when the operator presses down the minimize button of a content displayed on the screen, displays the content at a particular position on the screen in the form of an icon image indicating the type of that content.

### [Patent Document 1]

Japanese Patent Application Laid-open 2013-206317

However, in the conventional method, as the user minimizes a content displayed on the screen, the content is transformed into the icon that shows the type of the content, so the operator cannot confirm (view) the details of the content that has been iconized. Though, for example, Windows has a function of viewing the details of the content by placing the mouse pointer over the icon on the task bar, the user needs a operation of moving the mouse pointer to the position of the icon in order to confirm the details of the content.

In order to allow the operator to view the details of the content, it is also possible to display the content as an image reduced in size, instead of displaying the content in an icon representation. However, since when the content is displayed in reduced size, the title bar and the menu displayed thereon are also reduced in size as usual, poor visibility still poses problems.

When multiple pieces of content are downsized and displayed, the reduced size of each content is dependent on the distance between fingers when pinch-in operation is released. Therefore, it is difficult to reduce the multiple pieces of content in the same size. Further, the displayed position of the content is also dependent on the position when pinch-in operation is released. Accordingly, when the operator handles multiple pieces of content, a separate operation is needed to align the multiple pieces of content displayed on the screen.

Further, as stated above, the display reducing operation and the display iconizing operation are managed based on different operation flows. When the operator sorts desired pieces of content by comparing multiple pieces of content, the operator usually and often performs reducing and retraction of each content in a series of operation such as reducing a certain content in some degree, retracting a second content, placing a third content enlarged in some degree and the like. For this reason, it cannot be said that separate management of these operations is preferably when the operation scheme for sorting content is considered from a comprehensive viewpoint.

### SUMMARY OF THE INVENTION

In view of the above problem, it is therefore an object of the present invention to provide a content display device and the like in which, first, reducing operation and retracting operation can be performed in the same operation scheme, and secondly which can provide excellent visibility and good usability when the content is enlarged or downsized.

In view of the above problem, the present invention resides in a content display device for displaying content on a display screen, comprising: a first operation detector configured to detect a first operation on a displayed content; a first display controller that is configured to determine a display magnification ratio based on the operation quantity of the first operation and display a display image of the content that has been subjected to a first image processing for enlargement or reducing by the display magnification ratio; and, a second display controller that is configured to display a display image of the content that has been subjected to a second image processing when the display magnification ratio falls beyond a first threshold range.

The content display method of the invention is a content display method in a content display device for displaying content on a display screen, comprising: a first operation detection step of detecting a first operation on a displayed content; a first display step of determining a display magnification ratio based on the operation quantity of the first operation and displaying a display image of the content that has been subjected to a first image processing for enlargement or reducing by the display magnification ratio; and, a second display step of displaying a display image of the content that has been subjected to a second image processing when the display magnification ratio falls beyond a first threshold range.

The non-transitory recording medium of the invention is one that is recorded with a program for causing a computer that displays content on a display screen, to execute: a first operation detection step of detecting a first operation on a displayed content; a first display step of determining a display magnification ratio based on the operation quantity of the first operation and displaying a display image of the content that has been subjected to a first image processing for enlargement or reducing by the display magnification ratio; and, a second display step of displaying a display image of the content that has been subjected to a second image processing when the display magnification ratio falls beyond a first threshold range.

### ADVANTAGES OF THE INVENTION

According to the present invention, a display image of the content that has been enlarged or reduced in size by the display magnification ratio based on the operation quantity of the first operation is displayed. When the display magnification ratio is made higher than the first threshold by the first operation quantity, another display image of the content that has been processed by the second image processing is displayed. That is, it is possible to display one of display images that have been processed by different image processing, depending on the display magnification ratio even though the operator is performing the same first operation.

Therefore, according to the present invention, the operator can acquire a suitable display unconsciously without the need of operator's special operation, it is hence possible to provide a user-friendly content display device.

### BRIEF DESCRIPTION OF THE DRAWINGS

FIG. 1 is a diagram for illustrating the overall configuration of a content display device in the first embodiment of the present invention;

FIG. 2 is a diagram for illustrating the functional configuration of a content display device in the first embodiment of the present invention;

FIG. 3 is a chart for explaining a data configuration of process management information in the first embodiment of a content display device of the present invention;

FIG. 4 is an operation flowchart for explaining the basic process in the first embodiment of a content display device of the present invention;

FIG. 5 is a flowchart showing a special reducing process in the first embodiment of a content display device of the present invention.

FIG. 6A is a diagram for illustrating the operation of a special reducing process in the first embodiment of a content display device of the present invention;

FIG. 6B is a diagram for illustrating the operation of a special reducing process in the first embodiment of a content display device of the present invention;

FIG. 6C is a diagram for illustrating the operation of a special reducing process in the first embodiment of a content display device of the present invention;

FIG. 6D is a diagram for illustrating the operation of a special reducing process in the first embodiment of a content display device of the present invention;

FIG. 7 is a diagram for illustrating an operation example in the first embodiment of a content display device of the present invention;

FIG. 8 is a diagram for illustrating an operation example in the first embodiment of a content display device of the present invention;

FIG. 9 is a diagram for illustrating an operation example in the first embodiment of a content display device of the present invention;

FIG. 10 is a diagram for illustrating an operation example in the first embodiment of a content display device of the present invention;

FIG. 11 is an operation flowchart for explaining the basic process in the second embodiment of a content display device of the present invention;

FIG. 12 is an operation flowchart for explaining the process flow in the third embodiment of a content display device of the present invention;

FIG. 13A is a diagram for explaining an operation example in a content display device according to the third embodiment of the present invention;

FIG. 13B is a diagram for explaining an operation example in a content display device according to the third embodiment of the present invention;

FIG. 13C is a diagram for explaining an operation example in a content display device according to the third embodiment of the present invention;

FIG. 14 is an operation flowchart for explaining the basic process in the fourth embodiment of a content display device of the present invention;

FIG. 15 is a diagram for illustrating an operation example in the fourth embodiment of a content display device of the present invention;

FIG. 16 is a diagram for illustrating an operation example in the fourth embodiment of a content display device of the present invention;

FIG. 17 is an operation flowchart for explaining the basic process in the fifth embodiment of a content display device of the present invention;

FIG. 18 is a diagram for illustrating an operation example in the fifth embodiment of a content display device of the present invention;

FIG. 19 is a diagram for illustrating an operation example in the fifth embodiment of a content display device of the present invention;

FIG. 20 is an operation flowchart for explaining the basic process in the sixth embodiment of a content display device of the present invention;

FIG. 21 is a diagram for illustrating an operation example in the sixth embodiment of a content display device of the present invention;

FIG. 22 is an operation flowchart for explaining the basic process in the seventh embodiment of a content display device of the present invention;

FIG. 23 is a diagram for illustrating an operation example in the seventh embodiment of a content display device of the present invention;

FIG. 24 is a diagram for illustrating other operation example of a content display device of the present invention;

FIG. 25 is a diagram for illustrating other operation example of a content display device of the present invention;

FIG. 26 is a diagram for illustrating other operation example of a content display device of the present invention; and,

FIG. 27 is a diagram for illustrating other operation example of a content display device of the present invention.

### DESCRIPTION OF THE PREFERRED EMBODIMENTS

Next, the best mode for carrying out the present invention will be described with reference to the drawings. Herein, though, for description convenience, explanation will be made giving examples of embodiments, it goes without saying that the present invention can be applied to any apparatus as long as it is display-operable.

### 1. The First Embodiment

### 1.1 Overall Configuration

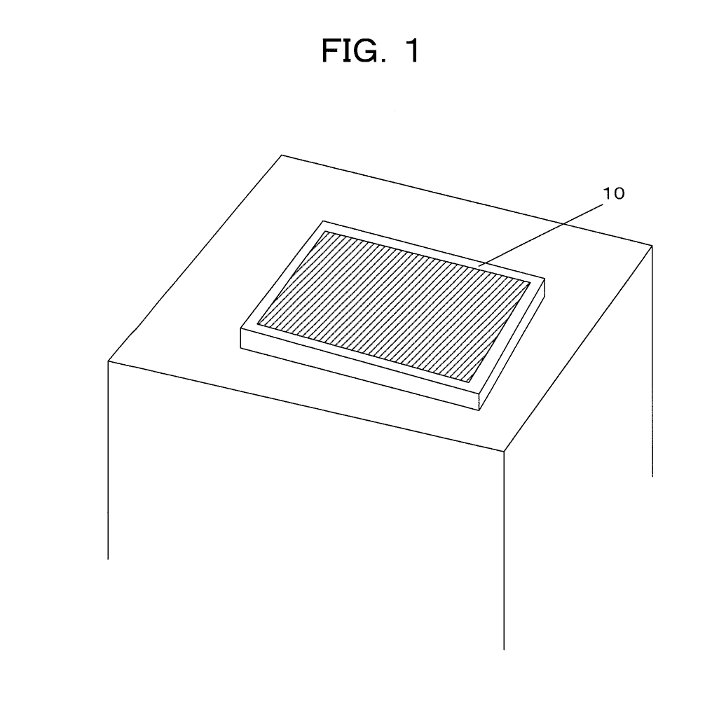

FIG. 1 is a view showing the appearance of a content display device 10 operable via a touch panel, to which a content display device of the present invention is applied.

The content display device 10 is integrally configured with a touch panel through which the operator operable.

Herein, the content display device 10 has a display screen having size and shape that allows a plurality of operators to operation. For example, the device can be used for business negotiations in front of the display screen and for various meetings where the display device is operated from four sides.

### 1.2 Functional Configuration

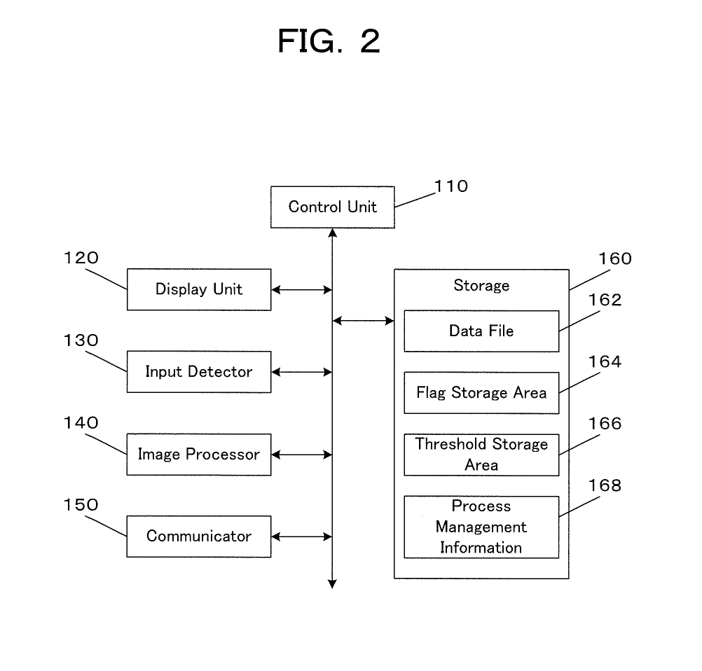

Referring next to FIG. 2, the functional configuration of the content display device 10 will be described. As shown in FIG. 2, the content display device 10 includes a control unit 110, a display unit 120, an input detector 130, an image processor 140, a communicator 150 and a storage 160.

The control unit 110 is a functional unit for controlling the content display device 10 as a whole. The control unit 110 loads and runs various programs stored in the storage 160 so as to realize various functionality. This, for example, is implemented by a CPU (Central Processing Unit) or the like.

The display unit 120 is a functional unit for displaying various pieces of information. For example, the display unit 120 is configured by a liquid crystal display (LCD), an organic EL (electroluminescence) display, or the like.

The input detector 130 is a functional unit for detecting input (operation) from the operator. In this embodiment, the input detector 130 is formed as a touch panel integrated with the display unit 120. The input detector 130 can detect various types of operation from the operator, such as tap, hold, slide, flick and pinch (pinch-in, pinch-out). Further, the input detector 130 can detect multiple inputs from operators. For example, the input detector 130 can detect five points at the same time or ten points at the same time.

Further, when a detected range is within a predetermined range and multiple points are detected as detected points, the input detector 130 may be adapted to detect that the predetermined range has been selected.

The image processor 140 is a functional unit for unfolding the content read out from a file, etc. to output display images and perform image processing such as filtering on the images. Herein, description on the conventional image processes (e.g., a process of extracting images to be displayed from the content, and a simple process of enlarging and reducing display of the display images) is omitted.

The communicator 150 is a network interface unit for connection to external networks such as the internet and other devices. For example, this is embodied by a NIC (Network Interface Card) or the like.

The storage 160 is a functional unit for storing various programs necessary for operating the content display device 10 as well as various kinds of data. The storage 160 is formed of, for example, a semiconductor memories, HDDs (Hard Disk Drive) and the like.

The storage 160 also stores various kinds of content as a data file 162. The content may include, for example, image data, video data as well as files displayable on the display unit 120 such as PDF (Portable Document Format) files, document files, presentation files and the like.

The storage 160 also secures a flag storage area 164 for storing flags, a threshold storage area 166 for storing thresholds. The flags and thresholds stored in these areas will be described in the embodiments hereinbelow.

Process management information 168 is information for managing the process being executed. It is assumed in this case that the display screen (the display area of the display unit 120) in the embodiment is managed by a process. A process may display either a single operation window or two or more (multiple) windows.

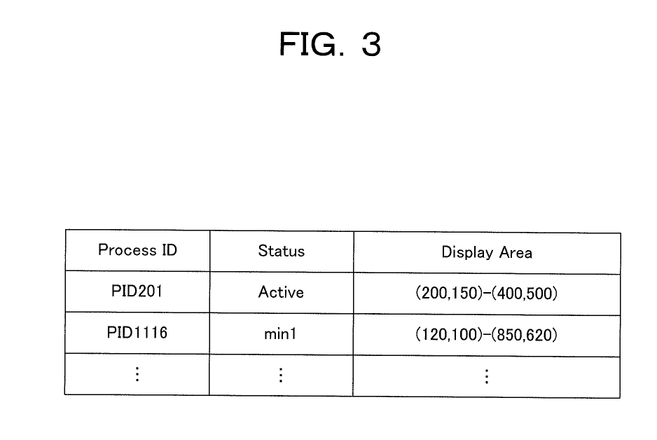

FIG. 3 shows one example of the process management information 168. The process management information 168 in the present invention embodiment includes a process ID (e.g., “PDN ID 201”) that identifies each process, status (e.g., “Active”) and display area (e.g., “(200, 150)-(400, 500)).

Examples of process statuses may include “Active” that indicates that the process is currently operable (displayed), “mini” that indicates that the content is displayed in a reduced size in a recognizable state, “mint” that indicates that the content is displayed in a reduced size in an iconized state, “sleep” that indicates that the process is suspended, and other states.

### 1.3 Processing Flow

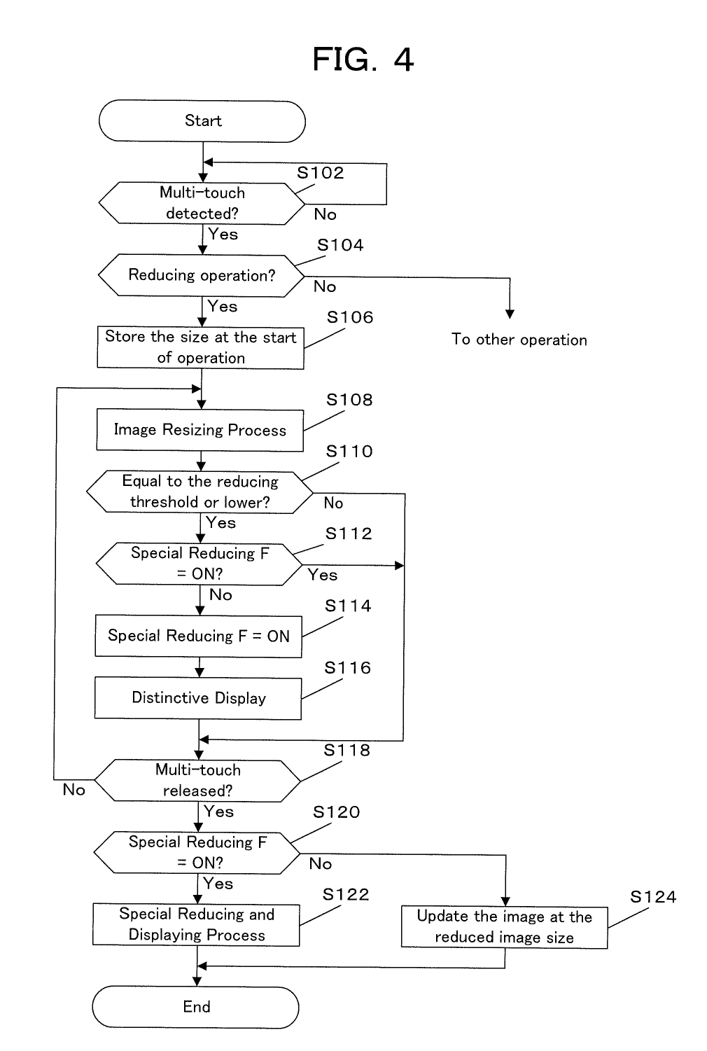

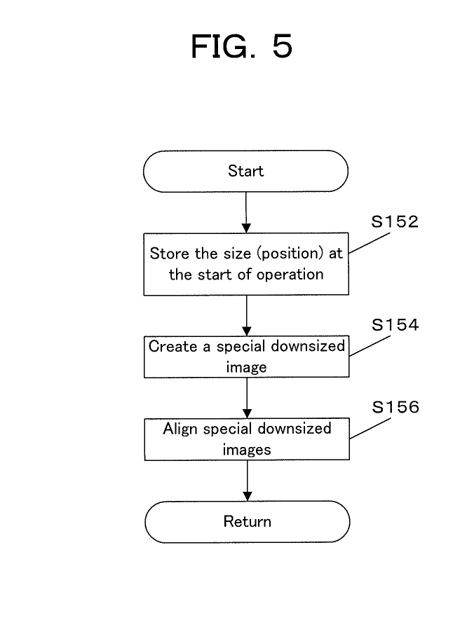

Next, the processing flow in the first embodiment will be described with reference to FIGS. 4 and 5. FIG. 4 shows the main process in the present embodiment.

First, when multi-touch is detected (Step S102; Yes), it is determined whether the event is a reducing operation (Step S104). A reducing operation herein in the present embodiment corresponds to a case where pinch-in operation is detected on the target display area (window).

When a reducing operation is detected (Step S104; Yes), the size of the display image (window) at the start of operation (the size and position at the start of operation) is stored (Step S106). Specifically, the display area in the process management information is updated.

Subsequently, an image resizing process is performed (Step S108). The image resizing process is a process to reduce or enlarge the display image by the operator performing a pinching gesture (pinch-in operation and pinch-out operation). Specifically, the image processor 140 (FIG. 2) creates a display image to be displayed on the display unit 120 (FIG. 2) from the content read out from data file 162 (FIG. 2) and outputs the image. In this case, the control unit 110 (FIG. 2) and/or the image processor 140 (FIG. 2) calculates (determines) the display magnification ratio based on the operation quantity of operator's pinch-in operation. At this time, as the first image processing, the content is enlarged or reduced simply based on the display magnification ratio and output as a display image.

Then, downsized window (enlarged window) is continuously displayed. The present embodiment will be described on the assumption that reducing operation (pinch-in operation) is performed.

Here, in the present embodiment, description will be made by assuming that the content window itself is downsized (enlarged) and displayed, but the outer frame of the window may be displayed so as to show the area size alone (that is, no content in the window is displayed).

At this stage, when the display magnification ratio of the display size (window size) of the downsized display image to the image size at the start of operation becomes equal to or lower than the reducing threshold (Step S110; Yes), it is checked whether a special reducing flag (which may also be abbreviated hereinbelow as “the special reducing F”) is “ON” (Step S112).

That is, it is determined whether the display magnification ratio falls beyond the predetermined range (predetermined threshold range) (whether the reducing ratio becomes equal to or lower than the reducing threshold and falls beyond the proper display magnification range, in this case). The above predetermined range does not include the threshold.

The reducing threshold is a value stored in threshold storage area 166 (FIG. 2). That is, if the display magnification ratio of the size of the window being operated becomes equal to or smaller than the reducing threshold (the display magnification ratio falls beyond the predetermined range), an aftermentioned special downsized view is displayed.

As examples of the reducing threshold, the threshold below which the reducing scheme is changed to special downsized display, such as the diagonal dimension equal to or shorter than 200 dots, one side equal to or shorter than 150 dots, or the like, has been stored beforehand in threshold storage area 166 (FIG. 2). This reducing threshold may be set arbitrarily by the user. Further, the threshold does not need to be a specific value, but may be set as a ratio such as 1/10 of the size of the full-screen.

The special reducing flag is a flag that is used to determine whether special downsized display has been performed. The special reducing flag is stored in flag storage area 164 (FIG. 2). For example, if a window is flagged with “ON”, this indicates that the window has been already displayed in special downsized display mode.

When the special reducing F is “OFF”, the special reducing F is set “ON”, the window is displayed in distinctive representation (Step S112; No->Step S114->Step S116). The distinctive representation herein may be given by, for example, a thick lined outer frame of the content (window), change in color, flashing display and/or the like. It is also possible to give an indication, by displaying “special downsized representation” in another area, by use of LED (Light Emitting Diode), by sound and/or the like.

At Step S110, when the display magnification ratio of the size of the window being operated is higher than the reducing threshold (when the display magnification ratio falls within the predetermined range) (Step S110; No), and if the special reducing F is “ON” at Step S112 (Step S112; Yes) or after distinctive display is performed (Step S116), it is determined whether multi touch has been released (Step S118).

If multi touch has not been released yet, the operation from Step S108 is repeated (Step S118; No->Step S108). When multi touch has been released, it is determined whether the special reducing F is “ON” or “OFF” (Step S118; Yes->Step S120).

Here, when the special reducing F is “OFF”, the content of the window is updated and displayed in the window size when multi touch was released (Step S120; No->Step S124). That is, the content that is downsized based on the display magnification ratio is output as the display image. At this point, the display area in process management information 168 (FIG. 2) is updated.

On the other hand, when the special reducing F is “ON”, a special reducing and displaying process is executed as the second image processing (Step S120; Yes->Step S122).

Now, the special reducing and displaying process will be described with reference to FIG. 5. First, the image size (position) at the start of operation is stored (Step S152). That is, the displayed area, size and others at the start of operation are stored.

In the present embodiment, this process is implemented by not updating the displayed area in the process management information. Here, it is possible to separately store the position and size of the window at the start of operation.

Subsequently, a special downsized image is generated (Step S154), and the generated special downsized image is displayed in alignment (Step S156).

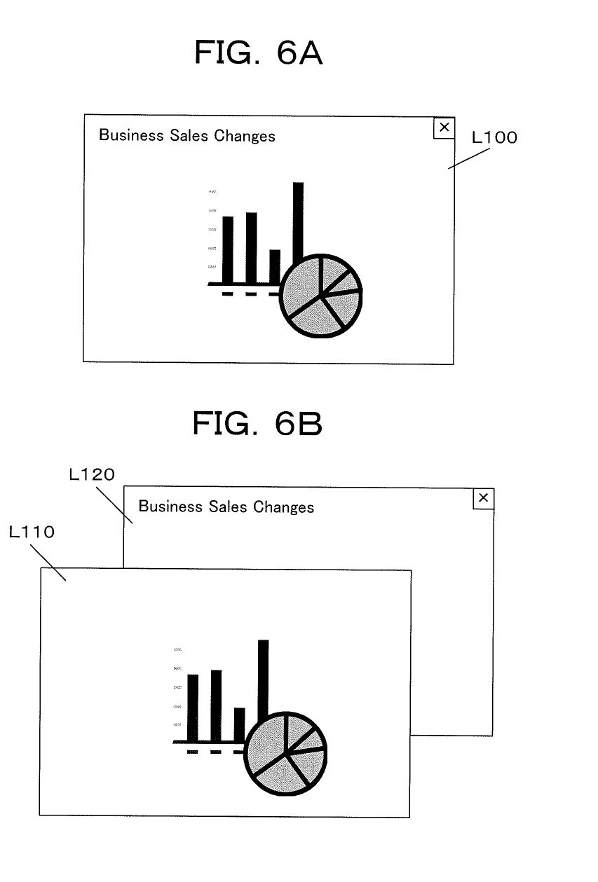

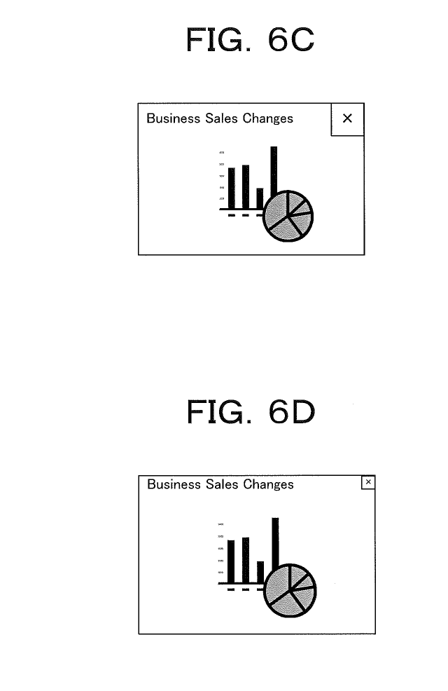

Herein, generation of a special downsized image will be described using FIGS. 6A to 6D. FIG. 6A shows a window L100 displayed on the display unit 120. The image displayed in window L100 is one that is extracted from the content and displayed. The image may be the content itself or the image of a currently displayed page when, for example the content is made up of a plurality of pages.

As shown in FIG. 6B, this window L100 is made up of a layer L110 and a layer L120. Specifically, window L100 is composed of layer L110 for figures, graphs, etc., that can be simply reduced and enlarged in size, and a layer L120 that will not be simply reduced or enlarged because of including text, operation icons, marks, etc.

With this configuration, for a special downsized image, layer L110 is simply downsized, whereas the view of layer L120 is downsized in a method different from the reducing of layer L110. Specifically, this reducing may be performed by mitigating the reducing ratio of layer L120 than that of layer L110 (a process of reducing the ratio of reducing), or by resizing text down only to the minimum front size, and others.

In this case, if text for the title etc., will not fit in, the text may be partly omitted or the layout may be modified to create a special downsized image. The thus created special downsized image is shown in FIG. 6 (c).

When compared to FIG. 6D or the general downsized image in which graphs (layer L110) and text (layer L120) are all downsized in the same display magnification ratio, the special downsized image (FIG. 6C) displays the text part in a greater size relative to the graph part. As a result, even in downsized representation, text etc., are visible so that it is possible to provide a user-friendly content display device 10 for the user (operator).

Though the above process is performed in order to make it easy to recognize the text part in the special downsized image (FIG. 6C), the image with graphs (layer L110) and text (layer L120) all downsized in the same display magnification ratio, shown in FIG. 6D, may be used as a special downsized image, or a ready made image may be used as a special downsized image.

Here, when a special downsized image is displayed, the special downsized image may be displayed so that the user can tell that the image in question is being displayed in a special downsized representation. For example, in a case of general display (a normal window or simple downsized display of an image with all the layers L110 and L120 downsized in the same display magnification ratio (general downsized image)), the title bar includes display of a title, cancel button, content type, priority and color for showing the level of preference, whereas the special downsized image may be displayed with color display and partial text of the title (e.g., the first five characters of the title) alone, instead.

Alternatively, it is possible to provide a configuration in which the title is hidden in the special downsized image and will appear when the operator touches the image or its vicinity with a finger or pen.

### 1.4 Operation Example

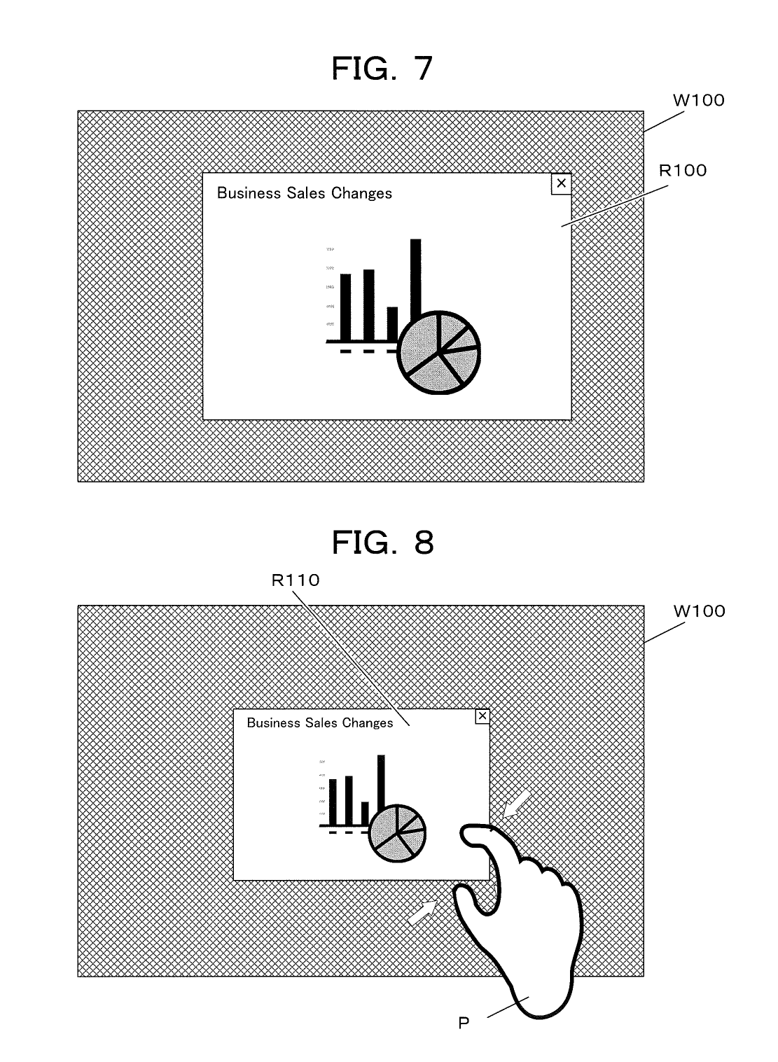

Next, the operation example of the present embodiment will be described with reference to the drawings. FIG. 7 shows a state where a window R100 is displayed on a display screen W100 (corresponding to the display unit 120 in FIG. 2). In this state, when the operator performs pinch-in operation on the display area of window R100, the display image (window) is downsized and displayed. FIG. 8 is a diagram showing the state of the image reduced in size.

At this stage, when operator P (FIG. 8) stops pinch-in operation and releases the touch, the shrink of display stops, forming a downsized window R110 (FIG. 8). In this case, the window is displayed in the general downsized representation, meaning that text and figures displayed in window R110 are all reduced at the same reduction ratio.

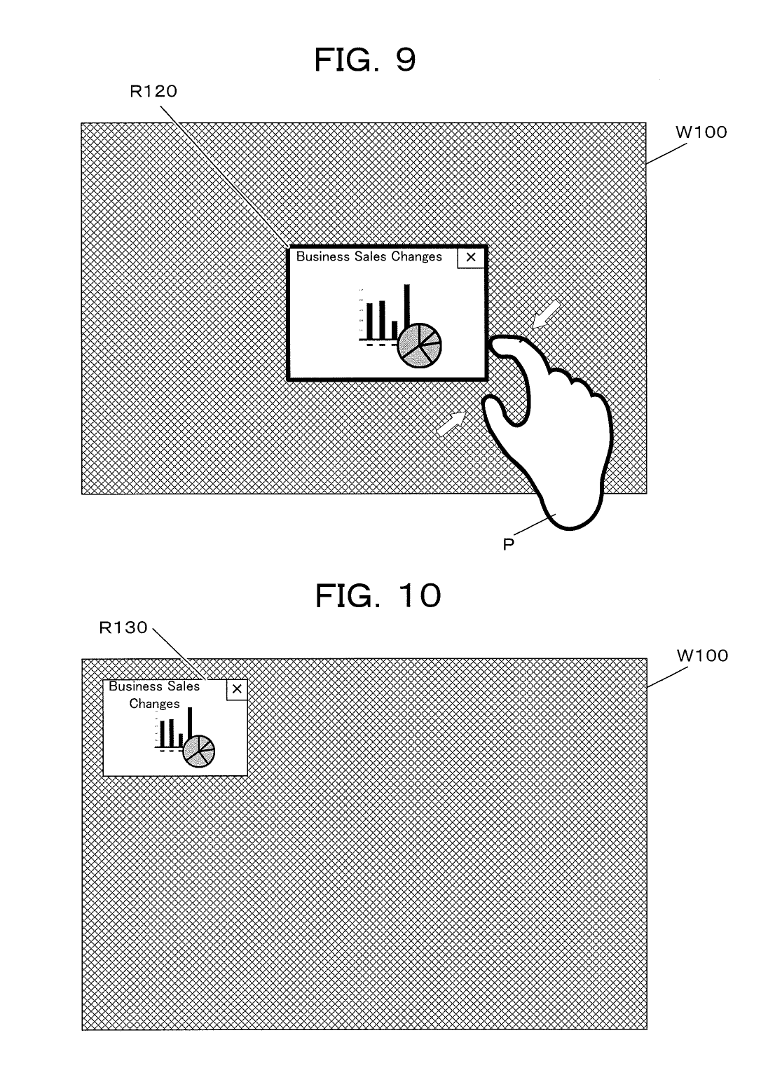

When pinch-in operation is further continued from the state shown in FIG. 8, the view changes to the state shown in FIG. 9. That is, by operator's continual pinch-in operation, window R120 (FIG. 9) is displayed in distinctive representation. This indicates that the process mode of display reducing reaches the special reducing display mode.

When operator P (FIG. 9) stops pinch-in operation and releases the touch at this stage, the window is displayed in the special downsized representation. FIG. 10 shows the state where the display image (window) is displayed in the special downsized representation. In this condition, a window R130 (FIG. 10) is displayed on display screen W100 (corresponding to the display unit 120 of FIG. 2) as a special downsized view.

In this case, the special downsized images are displayed in line. This provides the operator easy view of special downsized images in a list form. Here, the system may be configured so that each image of content can be displayed in the special downsized representation at the very place where it has been, instead of being aligned.

### 2. The Second Embodiment

Next, the second embodiment will be described. The first embodiment has been described by performing display reducing operation (pinch-in operation) for description convenience. This embodiment handle a case where pinch-out operation is performed halfway of the pinch-in control.

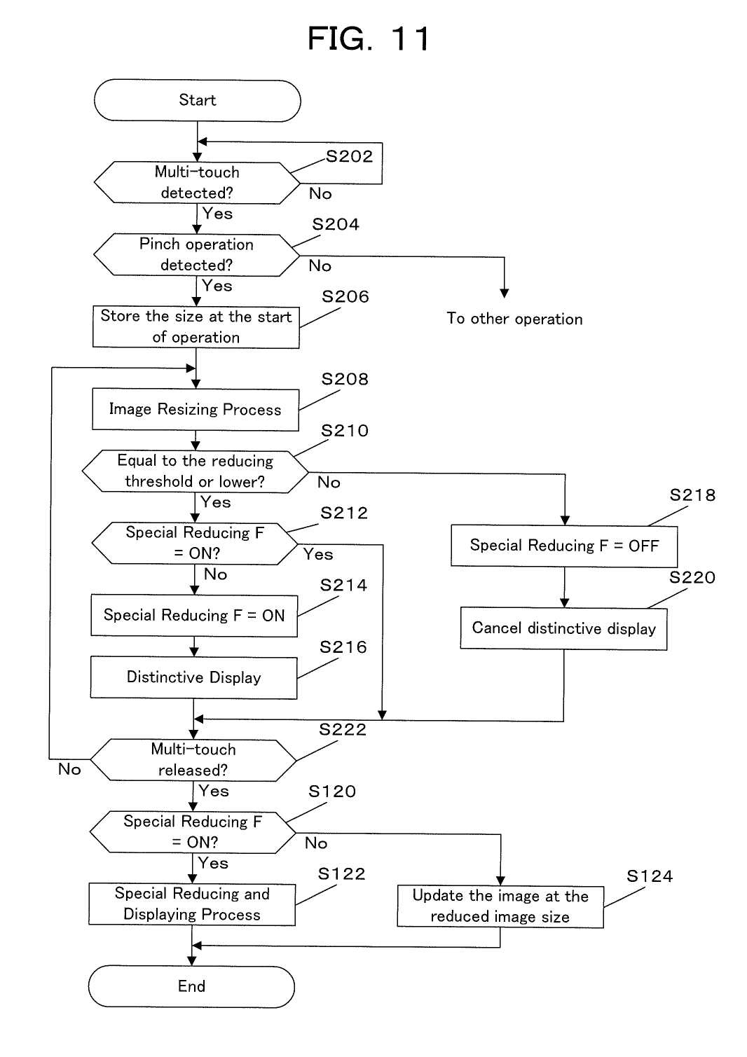

Since the device configuration and functional configuration of the second embodiment are the same as those of the first embodiment, the second embodiment will be presented by describing its processing flow without description of the configurations. That is, the operation of the second embodiment (FIG. 11) can be implemented by the same processing with that at and after Step S120 in the operation of the first embodiment (FIG. 4) and replacing the processing before Step S120, i.e., Steps S102 to S118 with processing from Steps S202 to S222.

First, when multi-touch is detected (Step S202; Yes), it is determined whether the touch is pinch operation (Step S204). At this step, if pinch operation has been detected, the size of display at the start of the pinch operation is stored (Step S206).

Subsequently, the display image is resized in accordance with the pinch operation (Step S208). Specifically, a size-reducing process is effected for pinch-in operation, whereas an enlarging process is effected for pinch-out operation.

It is determined whether the display magnification ratio of the display size of the current display image falls beyond the predetermined range (whether the reducing ratio becomes equal to or lower than the reducing threshold and falls beyond the proper display magnification range, in this case). When the display magnification ratio of the display size of the current display image is equal to or lower than the reducing threshold, it is checked whether a special reducing flag (which may also be abbreviated hereinbelow as “the special reducing F”) is “ON” (Step S210; Yes->Step S212). If the special reducing F is not yet “ON”, the special reducing F is set “ON” and distinctive display is performed (Step S212; No->Step S214->Step S216).

When, at Step S210, the current display image (window size) is enlarged to be greater than the reducing threshold (when the display magnification ratio falls within the predetermined range) (Step S210; No), the special reducing F is set “OFF” and distinctive display is canceled (Step S218->Step S220).

When the multi-touch is released (Step S222; Yes), the operation is effected in accordance with the special reducing F (Steps S120 to S124). On the other hand, if the multi-touch has not been released yet (Step S222; No), the operation from Step S208 is repeated.

In this way, in accordance with the present embodiment, when the content-based display image is reduced in size by pinch-in operation and when the display magnification ratio becomes equal to or lower than the reducing threshold, the display scheme changes from the general reducing display mode to the special reducing and displaying mode, whereas when the content is enlarged by pinch-out operation, the special reducing and operation of displaying mode is cancelled.

### 3. The Third Embodiment

Next, the third embodiment will be described. The third embodiment handles a case where plural modes of special reducing and displaying processing can be done.

That is, the display scheme can be switched between three modes based on pinch-in operation or pinch-output operation.

Specifically, a plurality of pieces of information are stored in threshold storage area 166 and process management information 168 in FIG. 2. This embodiment will be described taking a case where two pieces of information are stored.

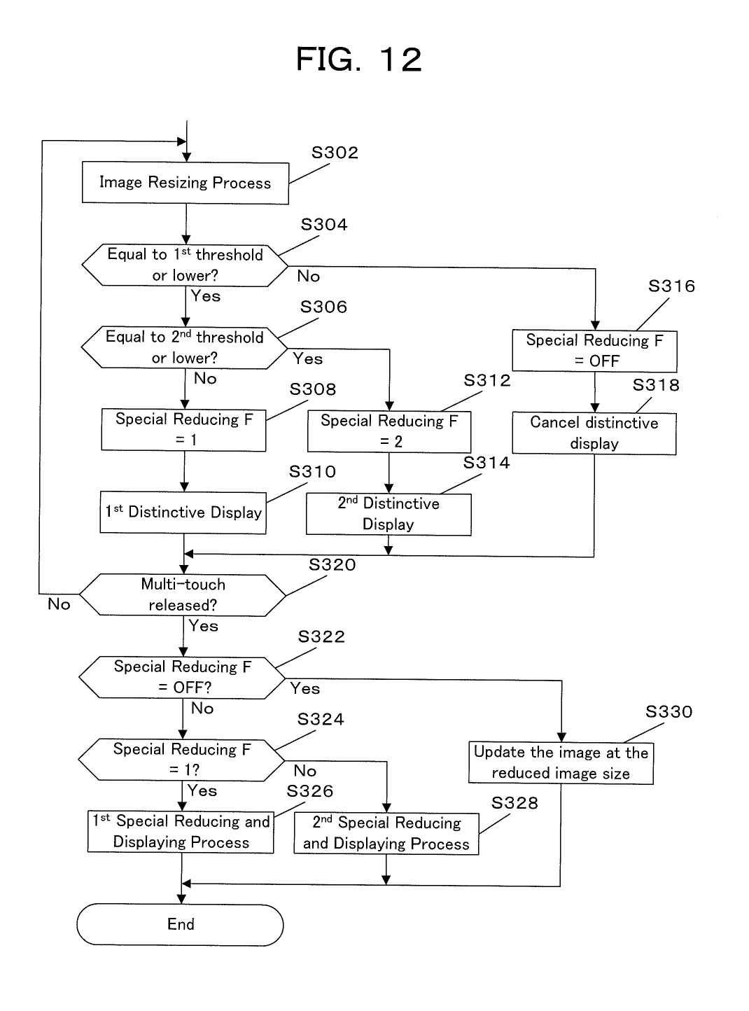

FIG. 12 shows an operation flow for explaining the process of the third embodiment. The operation of the third embodiment (FIG. 12) can be achieved by performing the same processing as that up to Step S206 in the second embodiment (FIG. 11) and the processing from Step S302 to S328 that replaces the processing from Steps S208 to S222 and Steps S120 to S124.

First, an image resizing process is effected in accordance with pinch-in operation or pinch-out operation performed by the operator (Step S302). At this point, the processing mode is changed depending on the display magnification ratio of the display size (window size) of the display image before and after the image resizing process, i.e., whether the display magnification ratio is equal to or lower than the second reducing threshold, falls within the range from the second reducing threshold to the first reducing threshold, or is higher than the first reducing threshold.

Specifically, when the display magnification ratio is equal to or lower than the second reducing threshold, the special reducing F is set at “2” to perform second distinctive display (Step S304; Yes->Step S306; Yes->Step S312->Step S314).

When the display magnification ratio is higher than the second reducing threshold and equal to or lower than the first reducing threshold, the special reducing F is set at “1” to perform first distinctive display (Step S304; Yes->Step S306; No->Step S308->Step S310).

When the display magnification ratio is higher than the first reducing threshold, the special reducing F is set with “OFF” to cancel distinctive display (Step S304; No->Step S316->Step S318).

With this arrangement, the process corresponding to the current window size will be done, and it is also possible for the operator to know which mode of processing has been performed, from its distinctive representation.

That is, after cancellation of multi-touch (Step S320; Yes), if the special reducing F is “1”, the first special reducing process is performed as the second image processing (Step S322; No->Step 234; Yes->Step S326). If the special reducing F is “2”, the second special reducing process is performed as the third image processing (Step S322; No->Step 234; No->Step S328). On the other hand, when multi-touch has not been released (Step S320; No), the operation from Step S302 is repeated.

The first special reducing process and the second special reducing process should be done in different ways. As an example, the first special reducing process may be a reducing process for producing a thumbnail-like representation while the second special reducing process may be a reducing process such as iconizing.

When the special reducing F is “OFF” (Step S322; Yes), the display image is updated in the reduced display image size, meaning that the size of the window currently displayed is retained in the size as it is and process management information 168 (FIG. 2) is updated (Step S330).

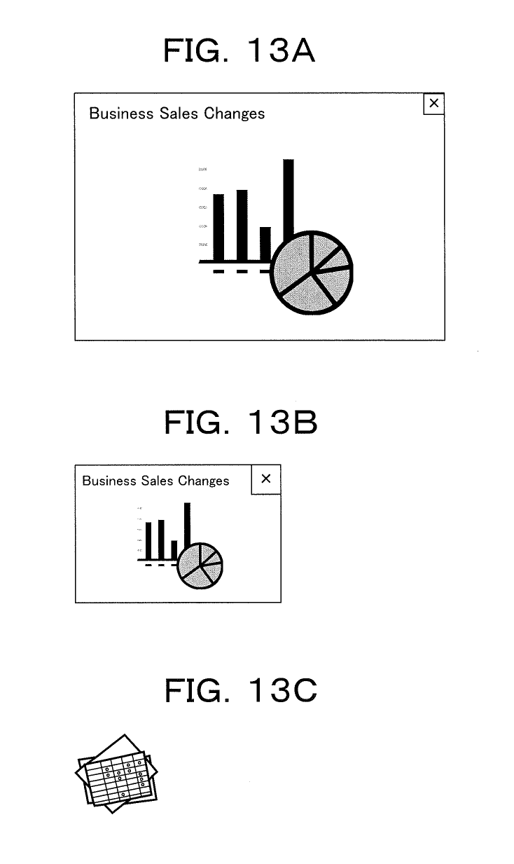

Referring next to FIGS. 13A to 13C, the operation example of the present embodiment will be described. In FIG. 13A, a normal window (the content) is displayed on the display screen (the display unit 120 in FIG. 2). Herein, the window of the content in its downsized state is shown in FIG. 13B. Here, the display image of normal content is scaled down and displayed. FIG. 13C shows a state where the content is iconized.

In the above, according to the present embodiment, a plurality of image processing can be changed over and implemented by the same operation (pinch operation).

### 4. The Fourth Embodiment

Next, the fourth embodiment will be described. The fourth embodiment is provided to explain that a list displaying process can be performed as one of different operations instead of special reducing and displaying process.

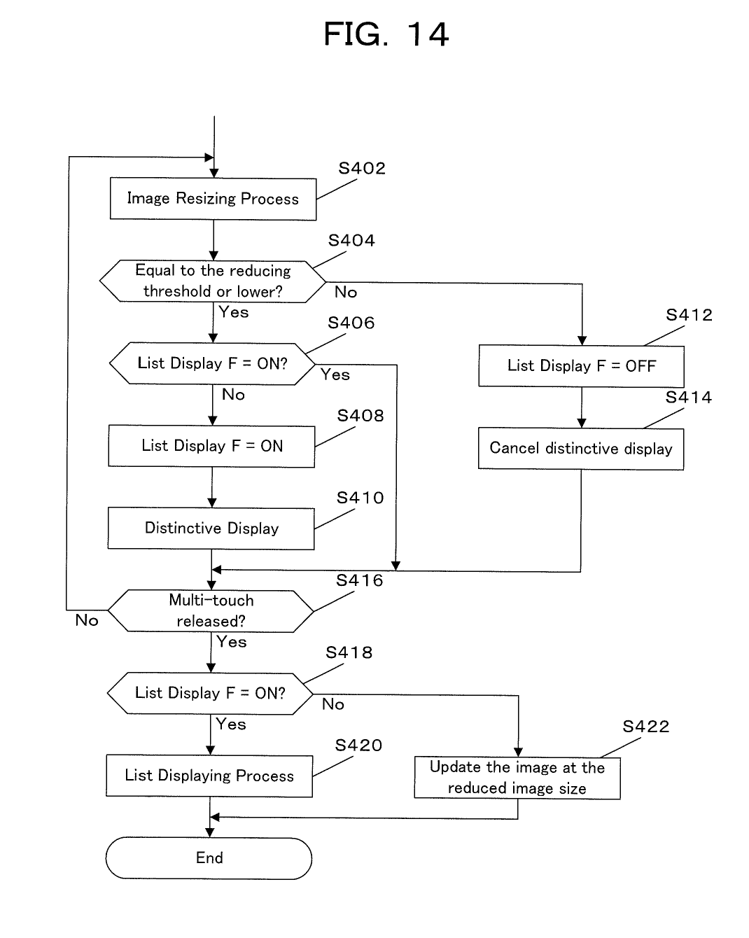

FIG. 14 shows an operation flow of the fourth embodiment. The operation of the fourth embodiment (FIG. 14) can be achieved by performing the same processing up to Step S206 of the operation in the second embodiment (FIG. 11) and the processing from Steps S402 to S422 that replaces the processing from Steps S208 to S222 and Steps S120 to S124.

First, after an image resizing process (Step S402), it is determined whether the display magnification ratio of the current display image size is equal to or lower than the reducing threshold (S404). That is, it is determined whether the display magnification ratio falls beyond the predetermined range (whether the reducing ratio becomes equal to or lower than the reducing threshold and falls beyond the proper display magnification range, in this case).

When the display magnification ratio of the display image size is equal to or lower than the reducing threshold (when the display magnification ratio falls beyond the predetermined range) (Step S404; Yes), and if a list display flag (which may also be abbreviated hereinbelow as “the list display F”) is not “ON”, the lift display F is set “ON” and distinctive display is performed (Step S406; No->Step S408->Step S410).

On the other hand, when, at Step S404, the display magnification ratio of the current display image size is higher than the reducing threshold (when the display magnification ratio falls within the predetermined range) (Step S404; No), the list display F is set “OFF” and distinctive display is canceled (Step S414).

At this point, when the operator's multi-touch has been released (Step S416; Yes), it is determined whether the list display F is “ON” (Step S418). When the list display F is “ON”, a list displaying process is effected as the second image processing (Step S418; Yes->Step S420). When multi-touch has not been released (Step S416; No), the operation from Step S402 is repeated.

On the other hand, if the list display F is “OFF” as a result of checking the list display F (Step S418; No), the display image is updated at the reduced display image size, meaning that the window currently displayed is kept in the size as it is and process management information 168 (FIG. 2) is updated (Step S422). That is, as the first image processing, the content (window) downsized based on the display magnification ratio (reduced display image size) is output as the display image.

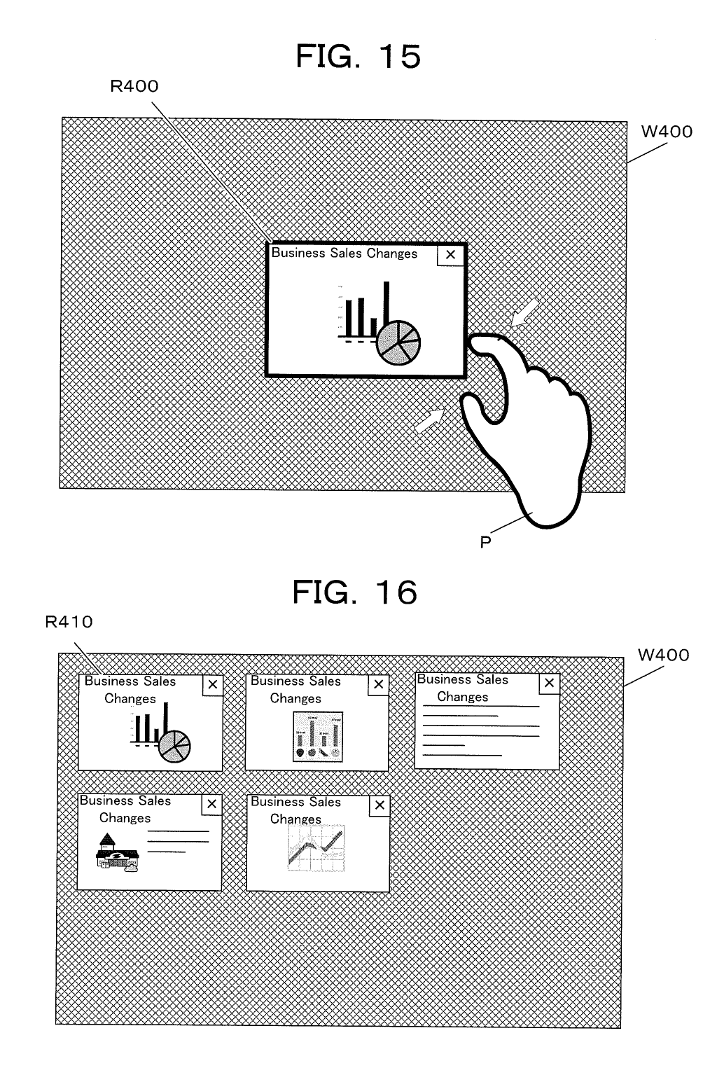

FIGS. 15 and 16 show an operation example in the present embodiment. In a display screen W400 (corresponding to the display unit 120 in FIG. 2) in FIG. 15, operator P (FIG. 15) performs pinch-in operation. Since window R400 is made smaller than the reducing threshold, distinctive display is performed.

FIG. 16 shows the state after pinch-in operation has been released in the condition shown in FIG. 15. As shown in FIG. 16, a group of windows are displayed as a window group R410. In this way, a plurality of windows are displayed to implement list display.

In the above way, according to the present embodiment, various types of processing can be achieved by the same operation. For example, as in this embodiment, processing such as a list displaying process can be implemented in addition to a special reducing and displaying process.

### 5. The Fifth Embodiment

Subsequently, the fifth embodiment will be described. The fifth embodiment handles a case where a display image is enlarged by pinch-out operation.

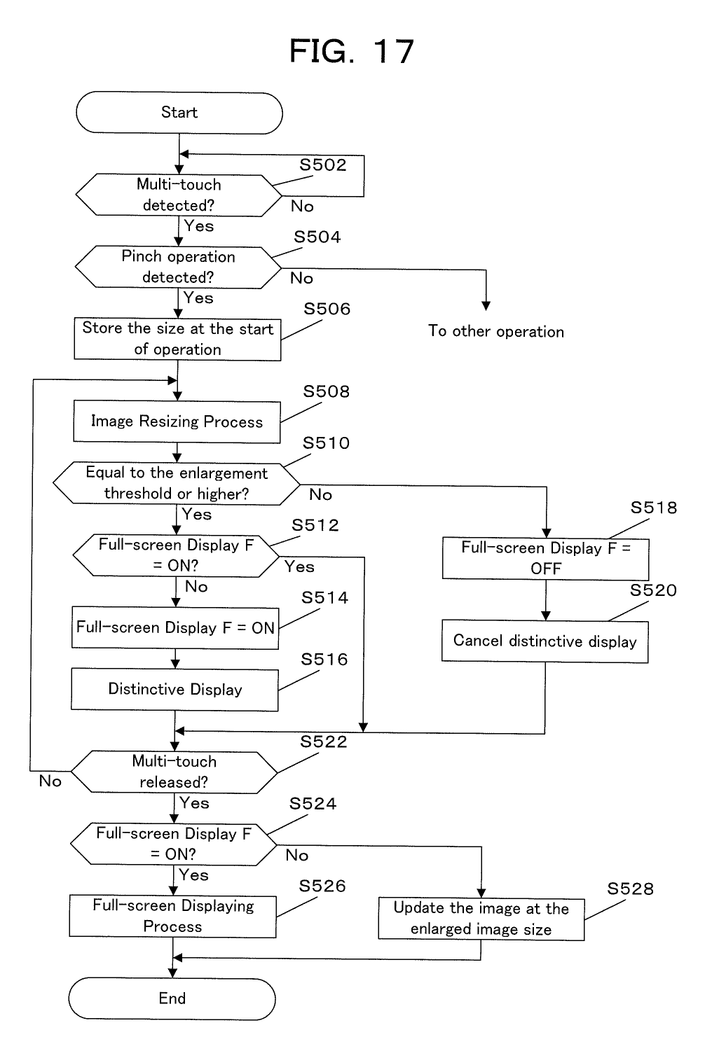

FIG. 17 shows an operation flow of the process in the fifth embodiment. When multi-touch is detected (Step S502; Yes) and then pinch operation (pinch-out operation in this case) is detected (Step S504; Yes), the operation start size is stored (Step S506).

In this case, an image resizing process is effected in accordance with the pinch operation (pinch-out operation in this case) (Step S508). For example, in the present embodiment the display magnification is increased by the pinch-out operation so that the display image is enlarged. Here, when pinch-in operation is performed, any one of the methods in the above first to fourth embodiments will be implemented.

It is determined whether the display magnification ratio of the size of the enlarged display image falls beyond the predetermined range (whether the enlargement ratio becomes equal to or higher than the enlargement threshold and falls beyond the proper display magnification range, in this case). When the display magnification ratio of the size of the enlarged display image is equal to or higher than the enlargement threshold (when the display magnification ratio exceeds the predetermined range) (Step S510; Yes), it is checked whether a full-screen display F is “ON” (Step S512). If the full-screen display F is not yet “ON”, the full-screen display F is set “ON” and distinctive display is performed (Step S512; No->Step S514->Step S516).

When the display magnification ratio of the size of the display image is lower than the enlargement threshold (when the display magnification ratio falls within the predetermined range) (Step S510; No), the full-screen display F is set “OFF” and distinctive display is canceled (Step S518->Step S520).

At this point, when the operator's multi-touch is released (Step S522; Yes), it is determined whether the full-screen display F is “ON” (Step S524). When the full-screen display F is “ON”, a full-screen displaying process is effected as the second image processing (Step S526). In the full-screen displaying process, the display image of the content is displayed in full-screen mode (Step S526). When multi-touch has not been released (Step S522; No), the operation from Step S508 is repeated.

On the other hand, if the full-screen display F is “OFF” based on the full-screen display F, the display image is updated at the enlarged display image size, meaning that the size of the window currently displayed is retained in the size as it is and process management information 168 (FIG. 2) is updated (Step S528). In this case, as the first image processing, the content (window) enlarged based on the display magnification ratio (enlarged display image size) is output as the display image.

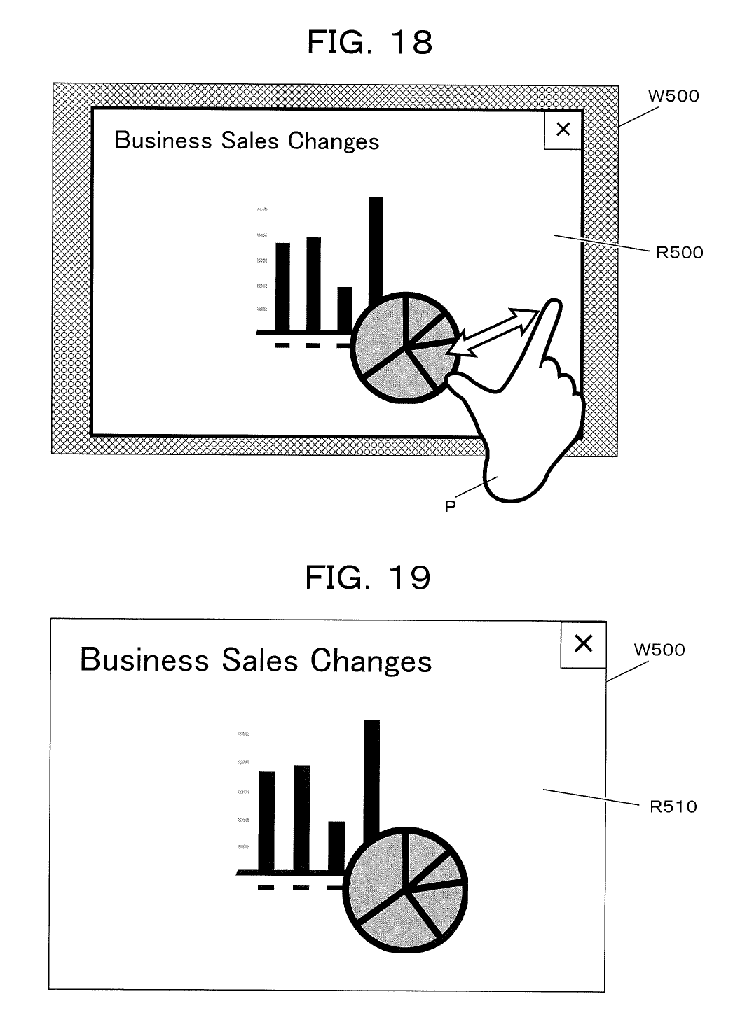

FIGS. 18 and 19 show an operation example in the present embodiment. In a display screen W500 (corresponding to the display unit 120 in FIG. 2) in FIG. 18, operator P (FIG. 18) performs pinch-out operation. Since window R500 has become greater than enlargement threshold, distinctive display is performed.

FIG. 19 shows the state after pinch-out operation has been released (that state in which multi-touch has been released) in the condition shown in FIG. 18. As shown in FIG. 19, the window is displayed in full-screen mode as a window R510.

In the above way, according to the present embodiment, various types of processing can be achieved by the same operation also when pinch-out operation for display enlargement is performed. For example, as in this embodiment, when enlargement display is performed, the window can be automatically changed to full-screen display mode when reaching a certain size.

### 6. The Sixth Embodiment

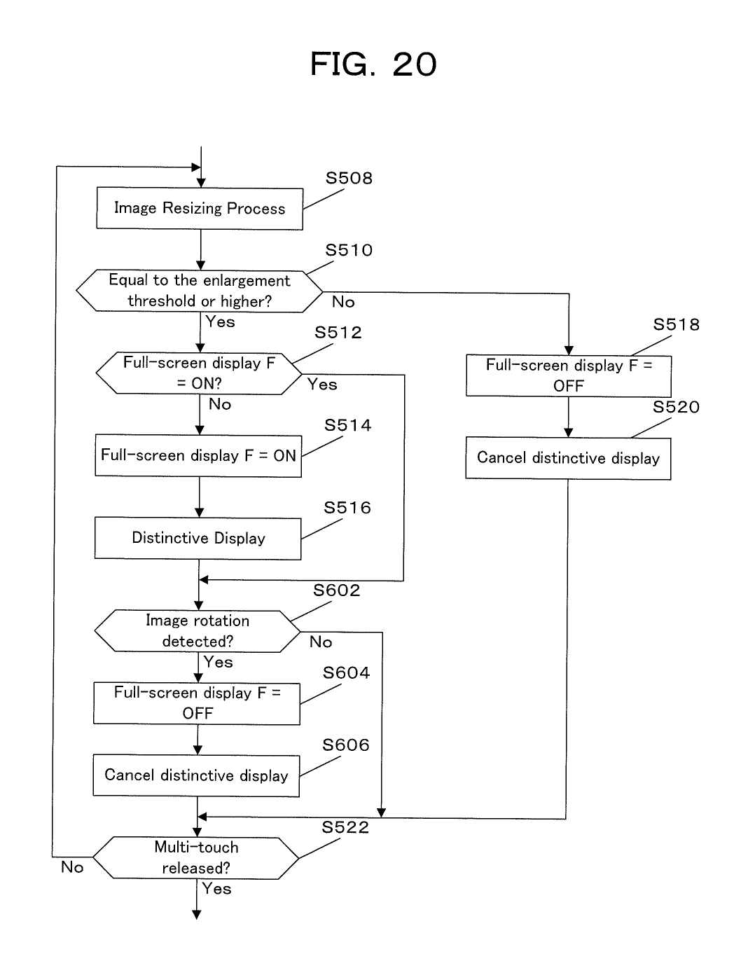

Next, the sixth embodiment will be described. The sixth embodiment handles a case where an in-progress operation of certain operation is canceled by performing another operation. The operation flow of this embodiment is shown in FIG. 20. In the operation of the sixth embodiment (FIG. 20), Steps S602 to S606 are added between Step S516 and Step S522 in the operation of the fifth embodiment. The same processing steps with those in the operation of the fifth embodiment (FIG. 17) are allotted with the same reference numerals, and their description is omitted.

From Steps S510 to S516, the display magnification ratio of the display image size (window size) has been set equal to or higher than the enlargement threshold and the window is being displayed in a distinctive representation, and in this condition, it is detected whether rotation operation is performed (Step S602).

Specifically, when the display image has been rotated by the operator's image rotation operation, the full-screen F is set “OFF” to cancel distinctive display (Step S602; Yes->Step S604->Step S606).

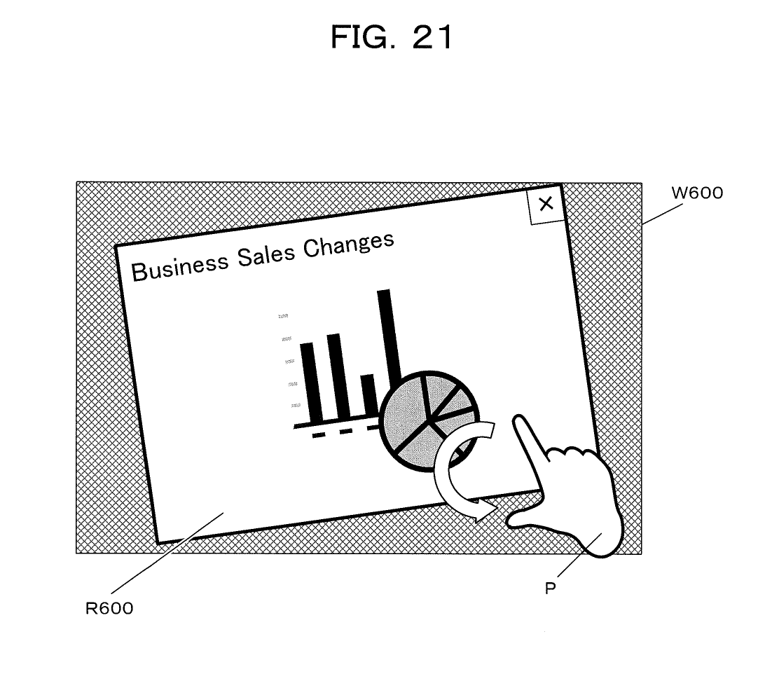

This makes it possible to perform a process whereby the display image is being enlarged without full-screen mode activated. FIG. 21 is a diagram showing the operation example at this case. In a display screen W600 (corresponding to the display unit 120 in FIG. 2), as operator P (FIG. 21) performs rotation operation, distinctive display is canceled so that full-screen mode will not be activated. In FIG. 21, when rotation operation is performed, the view of window R600 (FIG. 21) is rotated so as to make operator P visually know that rotation operation has been done. Here, it is also possible to make the operator visually recognize that full-screen mode will not be activated by displaying an icon instead of changing the view of window R600.

In the above way, according to the present embodiment, it is possible to perform cancel of the current process and the like by performing rotation operation during pinch-out.

Here, in this case the currently enlarged display image may be simply used or the display image may be reverted back to the initial display image, without activating full-screen display.

Though the present embodiment has been described based on pinch-out, it is also possible to perform a similar process when pinch-in is performed.

Further, through the present embodiment has been described giving an example of rotation operation, any operation may be used as long as it is a gesture different from the current one. For example, other operation such as swipe gesture, flick gesture, etc., or new detection of a touch with three or more points of contact may be used.

### 7. The Seventh Embodiment

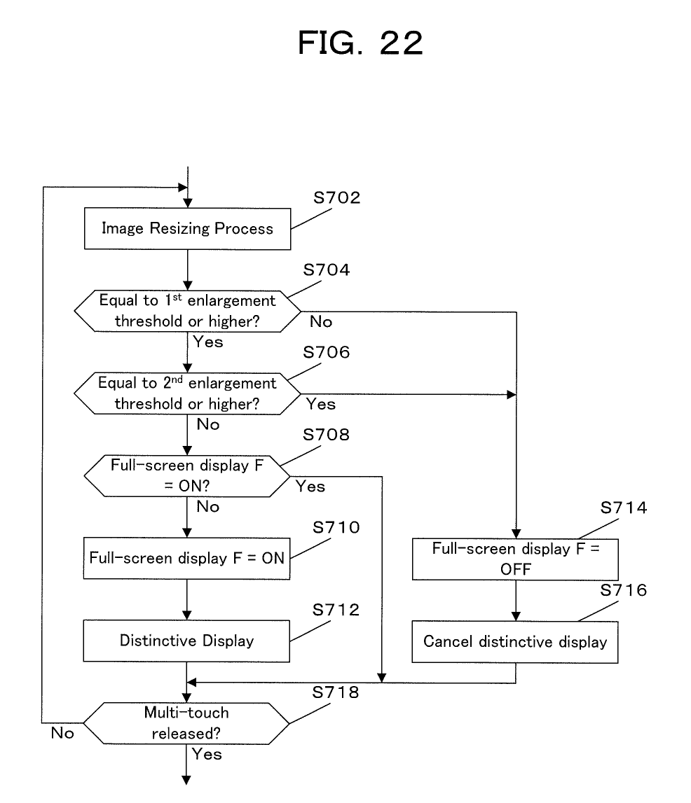

Next, the seventh embodiment will be described. The seventh embodiment handles a case where the window of the content that has entered full-screen mode by continuous pinch-out operation, is activated into enlarging mode by further continuous pinch-out operation. FIG. 22 shows an operation flow of this embodiment. In the operation of the seventh embodiment (FIG. 22), the processing steps, Steps S508 to S522, are replaced by Steps S703 to S718.

After implementation of an image resizing process (Step S702), it is determined whether the display magnification ratio of the current display image size (window size) is equal to or higher than the first enlargement threshold. At this stage, when the display magnification ratio is equal to or higher than the first enlargement threshold but lower than the second enlargement threshold, and if the full-screen display F is not yet “ON”, the full-screen display F is set “ON” and distinctive display is performed (Step S704; Yes->Step S706; No->Step S708; No->Step S710->Step S712).

However, when the ratio is equal to or higher than the first enlargement threshold, and when further operation for display enlargement (pinch-out operation) is performed so that the above ratio is equal to or higher than the second enlargement threshold, the full-screen display F is set “OFF” so that distinctive display is canceled (Step S704; Yes->Step S706; Yes->Step S714->Step S716).

Then, as multi-touch is released (Step S718; Yes), the display image is displayed in an enlarged view or in full-screen mode, in accordance with the current full-screen display F. Specifically, when the display magnification ratio of the display image size falls between the first enlargement threshold and the second enlargement threshold, the display image is displayed in full-screen mode, whereas when the ratio exceeds the second threshold, the display image is further enlarged. On the other hand, when multi-touch has not been released (Step S718; No), the operation from Step S702 is repeated.

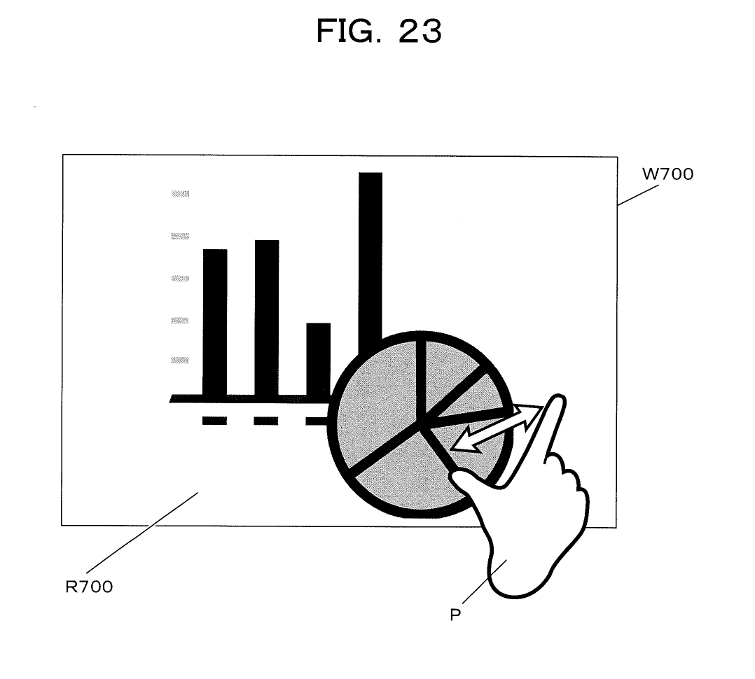

FIG. 23 is a diagram showing the operation example of the seventh embodiment. FIG. 23 shows an operation of additional enlargement from the state shown in FIG. 18. In this way, in a display screen W700 of FIG. 23 (corresponding to the display unit 120 in FIG. 2), a window R700 (FIG. 23) having part of an enlarged display image is displayed in full-screen mode.

In the above way, according to the present embodiment, a plurality of processing can be changed over from one mode to another and once again returned to the original mode even within the same operation. In particular, for enlargement operation, there has been a demand for expanding part of the display image. This embodiment is effective in such a case.

### 8. Variational Examples

As the embodiments of the invention have been described in detail with reference to the drawings, the specific configuration should not be limited to the embodiments. Designs and others that do not depart from the gist of this invention should also be included in the scope of claims.

Though, in the above embodiments, explained is about large-sized content display devices which can also be applied to small-sized content display devices, tablet type terminals and the like. It goes without saying that the invention can be realized in touch-operable television devices, car navigation systems and other device.

Though, for description convenience, the above embodiments have been described separately for each process, it is of course possible to realize these embodiments in combination. For example, as to pinch operation, it is possible to adopt the second embodiment while pinch-in operation is being performed and the fifth embodiment while pinch-out operation is being performed.

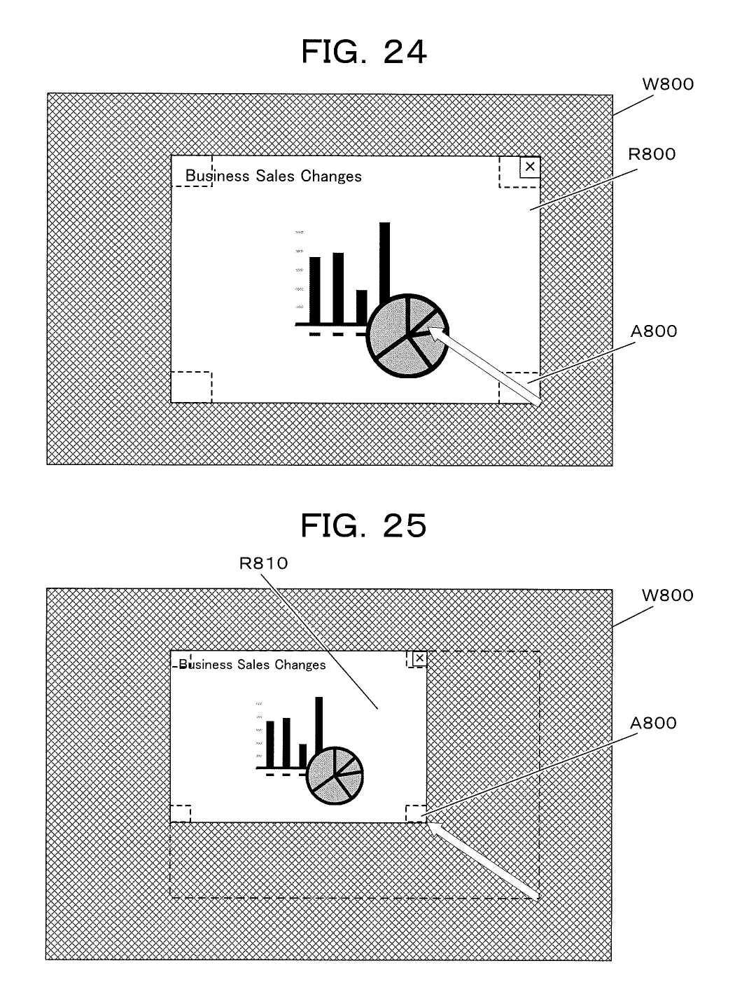

Though, in the above embodiments, explained is about pinch-in operation or pinch-out operation as reducing operation or enlargement operation which can also be realized in other operations. Other operations can include an operation of touching and sliding, an operation of selecting and sliding using a pointing device and the like. FIGS. 24 to 27 show other operation examples.

FIG. 24 shows a state where a display image (a window R800) is displayed on a display screen W800 (corresponding to the display unit 120 in FIG. 2). The corners of the display area of the window R800 are resizable operating area A800. When in this state the operator performs a drag operation on the window R800, the window R800 is downsized and displayed. This drag operation is an operation of touching (selecting) the operating area A800 on the window R800 and sliding the operating area A800 inward to the center of the window R800. FIG. 25 is a diagram showing the state of the image reduced in size. At this stage, when operator stops the drag operation and releases the touch (select), the shrink of display stops, forming a downsized window R810.

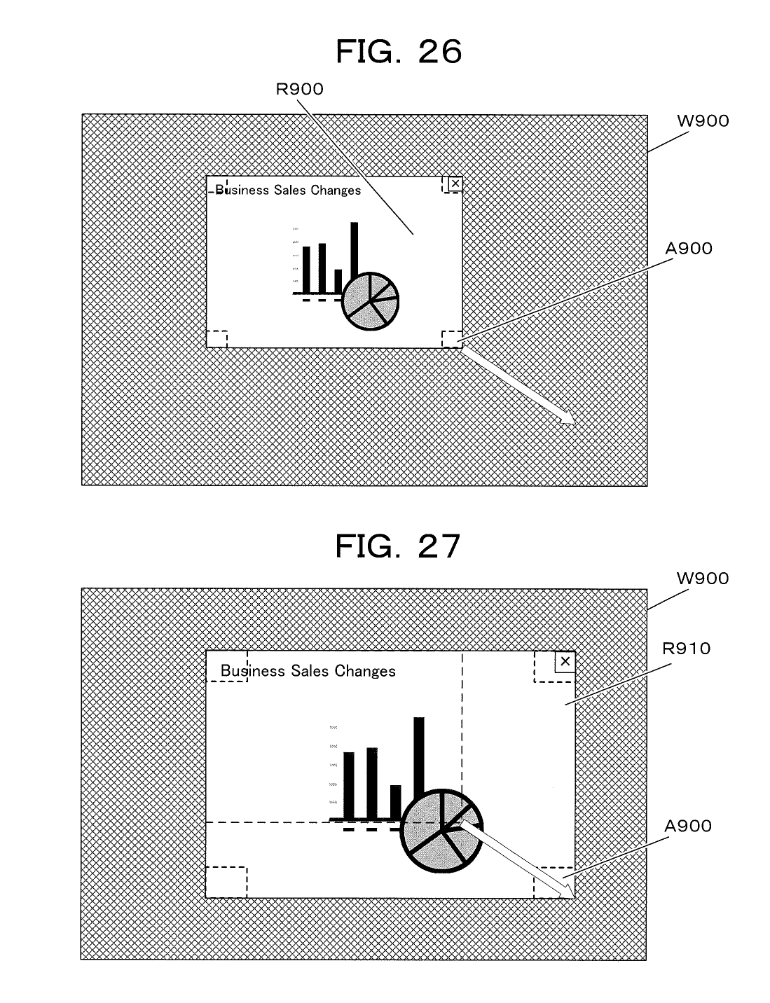

FIG. 26 shows a state where a display image (a window R900) is displayed on a display screen W900 (corresponding to the display unit 120 in FIG. 2). The corners of the display area of the window R900 are resizable operating area A900. When in this state the operator performs a drag operation on the window R900, the window R900 is downsized and displayed. This drag operation is an operation of touching (selecting) the operating area A900 on the window R900 and sliding the operating area A900 in a direction away from the window R800. FIG. 27 is a diagram showing the state of the image enlarged in size. At this stage, when operator stops the drag operation and releases the touch (select), the enlargement of display stops, forming a downsized window R910.

The program to be operated in each device of the embodiment may be a program (program that makes a computer function) for controlling a CPU or the like so as to realize the functions of the embodiment described above. The information to be handled in these devices is temporarily stored in temporary memory (e.g., RAM (Random Access Memory) at the time of processing, then is stored into storages such as various kinds of ROM (Read Only Memory) and/or HDDs, and is read out, modified and written in by the CPU, as necessary.

Herein, the recording medium for storing the program may be any of semiconductor mediums (e.g., ROM, non-volatile memory card, etc.), optical recording mediums/magneto optical mediums (e.g., DVD (Digital Versatile Disc), MO (Magneto Optical Disc), MD (Mini Disc), CD (Compact Disc), BD and the like), magnetic recording mediums (e.g., magnetic tape, flexible disc, etc.), and the like. Further, the functions of the above-described embodiments are not only realized by executing the loaded program, but the functions of the present invention may also be realized in accordance with the instructions of the program being executed in cooperation with an operating system, another application program or the like.

To put the product on the market, the program may be stored on a removable storing medium, or may be transferred to a server computer connected to a network such as the Internet or the like. In this case, the storage device of the server computer is also included in the present invention.

Further, the whole or part of each device in the above-described embodiments may also be typically realized by an LSI as an integrated circuit. Each functional block of each device may be given individually in the form of a chip, or the whole or part may be integrated into a chip. The method of circuit integration may be realized in the form of a dedicated circuit or general purpose processing unit, not limited to LSI. It goes without saying that if a technology of circuit integration replacing LSI technologies appears with the progress of semiconductor technologies, the integrated circuit based on that technology can also be used.

### DESCRIPTION OF REFERENCE NUMERALS

10 content display device
110 control unit
120 display unit
130 input detector
140 image processor
150 communicator
160 storage
162 data file
164 flag storage area
166 threshold storage area
168 process management information

What is claimed is:

1. A content display device for displaying content on a display screen, comprising:
a first operation detector configured to detect a first operation on a displayed content;
a first display controller that is configured to determine a display magnification ratio based on the operation quantity of the first operation and display a display image of the content that has been subjected to a first image processing for enlargement or reducing by the display magnification ratio; and,
a second display controller that is configured to display a display image of the content that has been subjected to a second image processing when the display magnification ratio falls beyond a first threshold range.

2. The content display device according to claim 1, further comprising:
a third display controller that is configured to display a display image of the content that has been subjected to a third image processing when the display magnification ratio falls beyond a second threshold range.

3. The content display device according to claim 1, further comprising a second operation detector configured to detect a second operation, wherein when the second operation has been detected, the display image is output by the first display controller even if the display magnification ratio falls beyond a predetermined threshold range.

4. The content display device according to claim 1, wherein the first operation is a pinch-in operation or a pinch-out operation, and the second display controller displays a display image of the content that has been subjected to a special reducing and displaying process as the second image processing when the display magnification ratio is equal to or lower than the predetermined threshold.

5. The content display device according to claim 4, wherein the special reducing and displaying process outputs a display image by reducing the content and text in the content by different reducing ratios.

6. The content display device according to claim 1, wherein the first operation is a pinch-out operation, and the second display controller displays the display image of the content in full-screen mode as the second image processing when the display magnification ratio has become equal to or higher than the predetermined threshold.

7. A content display method in a content display device for displaying content on a display screen, comprising:
a first operation detection step of detecting a first operation on a displayed content;
a first display step of determining a display magnification ratio based on the operation quantity of the first operation and displaying a display image of the content that has been subjected to a first image processing for enlargement or reducing by the display magnification ratio; and,
a second display step of displaying a display image of the content that has been subjected to a second image processing when the display magnification ratio falls beyond a first threshold range.

8. A non-transitory recording medium recorded with a program for causing a computer that displays content on a display screen, to execute:
a first operation detection step of detecting a first operation on a displayed content;
a first display step of determining a display magnification ratio based on the operation quantity of the first operation and displaying a display image of the content that has been subjected to a first image processing for enlargement or reducing by the display magnification ratio; and,
a second display step of displaying a display image of the content that has been subjected to a second image processing when the display magnification ratio falls beyond a first threshold range.
